(19) United States
(12) Patent Application Publication
(10) Pub. No.: US 2005/0226337 A1
(43) Pub. Date: Oct. 13, 2005

(54) 2D block processing architecture

(76) Inventors: Mikhail Dorojevets, Port Jefferson, NY (US); Eiji Ogura, Sunnyvale, CA (US)

Correspondence Address: Jonathan O. Owens;HAVERSTOCK & OWENS LLP, 162 North Wolfe Road, Sunnyvale, CA, 94086, US

(21) Appl. No.: 10/816,391

(22) Filed: Mar. 31, 2004

(51) Int. Cl. H04N 7/12

(52) U.S. Cl. 375/240.24; 375/240.12

(57) ABSTRACT

A video platform architecture for video processing includes complex video compression/decompression algorithms in a computer with a two-dimensional Single-Instruction Multiple-Data (SIMD) array architecture. The video platform architecture includes one or more video processing modules, on-chip shared memory, and a general-purpose RISC central processing unit CPU used as a system controller. Each video processing module includes a rectangular array of processing elements (PEs), a block load/store unit, a global-accumulation unit. Video to be processed is configured into blocks of data, and a general-purpose CPU used as a local controller. A plurality of registers are provided in the processing elements and the block load/store unit to support two-dimensional processing of the data blocks. Types of registers used include block registers, vector registers, scalar registers, and exchange registers. Each of these registers is designed to hold a short ordered one- or two-dimensional set of video data (data blocks). These registers are arranged in a hierarchical configuration along the data flow path between the on-chip memory and processing units within the PE array.

### FIELD OF THE INVENTION

The present invention relates to the field of video processing. More particularly, the present invention relates to the field of video processing using 2D block processing architecture.

### BACKGROUND OF THE INVENTION

Previous and current video processing techniques have only been partially successful when applied to current video processing algorithms because of significant control and addressing overhead, and high clock rate and power consumption requirements. These limitations resulted because the architectures used were designed to operate on data objects different from those that are typical in current video processing algorithms. Examples of such video processing architectures include pure vector, array, VLIW (Very Long Instruction Word), DSP (Digital Signal Processing), and general purpose processors with micro-SIMD (single-instruction multiple-data) extensions.

A parallel single-instruction multiple-data (SIMD) array architecture, having a two-dimensional rectangular array of processing elements (PEs) operating on its own set of data, is an architecture used for high-performance video processing applications. Programmable array architectures, using processing elements with varied complexity, are often referred to as being memory-oriented. The processing elements in such memory-oriented architectures operate on video streams from memory, or adjacent processing elements, and the results are written back to memory. While peak processing capabilities of such programmable array architectures can be quite high, their poor reuse of data leads to intensive memory traffic. As a result, performance suffers due to limited memory bandwidth available in such systems. This significantly limits the video standard complexity, frame rate, and size achievable with such programmable array architectures.

For extremely high-performance mobile applications requiring relatively low clock rate and power consumption compared to general purpose processors with micro-SIMD extensions, hard-wired array implementations of video algorithms are found to be efficient. Such application specific integrated circuits (ASICs) can reach high performance and low power consumption by providing a set of specialized units and interconnect structure tuned for video algorithm and data characteristics. ASICs efficiently reuse data fetched from memory into PEs, data created by PEs via the use of delay/buffer registers holding intermediate results, or data already fetched from memory, thus significantly decreasing the memory traffic. Unfortunately, ASICs have very limited to no programmability, and high development and verification costs. With costs of such ASICs currently reaching 60% or more of the cost of consumer video products, it is desirable to develop a solution that combines advantages of programmable SIMD array architectures with the efficiency and performance of video ASICs.

### SUMMARY OF THE INVENTION

A video platform architecture for video processing includes complex video compression/decompression algorithms in a computer with a two-dimensional Single-Instruction Multiple-Data (SIMD) array architecture. The video platform architecture includes one or more video processing modules, audio and bit-stream processing units, on-chip shared memory, a direct memory access unit DMA to transfer data between the off-chip DRAM and the on-chip shared memory, and a general processing unit CPU used as a system controller. Each video processing module includes a rectangular array of processing elements (PEs), a block load/store unit, a global accumulation unit, and a general-purpose CPU used as a local controller. Video to be processed is configured into blocks of data. A plurality of registers are provided in the processing elements and the block load/store unit to support two-dimensional processing of the data blocks. Types of registers used include block registers, vector registers, scalar registers, and exchange registers. Each of these registers is designed to hold a short ordered one- or two-dimensional set of video data (data blocks). These registers are arranged in a hierarchical configuration along the data flow path between the on-chip memory and processing units within the PE array.

In one aspect, a video processing apparatus includes a memory, and one or more video processing modules, each video processing module coupled to the memory and comprising a programmable array of processing elements, each processing element including local registers to provide data used in processing operations and to store results of the processing operations, a block load and store unit coupled to the programmable array of processing elements to load, store, and send data transferred back and forth between the memory and the array of processing elements, a global accumulation unit to accumulate the results of the processing operations for each processing element, and a local controller to provide instructions and parameters related to the processing operations and data transfer The array of processing elements comprises a two-dimensional array. The two-dimensional array comprises a 4×4 array of processing elements. The two-dimensional array comprises a single-instruction multiple-data array. Each processing element includes a plurality of vector registers and a plurality of block registers. Each vector register and each block register is configured to hold 8 8-bit data elements as a two-dimensional 2×4 block of pixels or 4 16-bit data elements as a one-dimensional vector. The block load and store unit comprises one or more arrays of exchange registers. Each array of exchange registers is a two-dimensional array. The local controller provides control commands to each processing element, performing control and processing operations on data stored within the local controller, and transfers data between the local controller and other registers within one video module. The apparatus further comprises a system controller coupled to the memory and to the one or more video processing modules. The apparatus further comprises a direct, high-bandwidth data path to couple each of the video processing modules to the memory. Each processing element further comprises a plurality of scalar registers. The block load and store unit sends data transferred back and forth between non-adjacent processing elements of the array of processing elements. Each processing element includes a local accumulation register. Each processing element further comprises a plurality of control registers including a PE mask register, a condition register, a block base register, and a vector base register. The block load and store unit sends data transferred back and forth between the local registers in the processing elements, the global accumulation unit, and the local controller.

In another aspect, a method of processing video comprises configuring a video stream into data blocks, loading data blocks from memory to a first array of exchange registers, loading data blocks from the first array of exchange registers to a programmable array of processing elements, wherein each processing element within the array of processing elements includes an array of block registers, an array of vector registers, and a local accumulator, the data blocks are loaded from the first array of exchange registers to the array of block registers, loading the data blocks from the array of block registers to the array of vector registers, processing the data blocks loaded in the array of vector registers and storing results in the corresponding local accumulator for each processing element, accumulating the results stored in the local accumulators in a global accumulator, thereby forming accumulated results, and moving the accumulated results into a local controller. The method further comprises storing results from processing the data blocks in the array of vector registers, and loading the results stored in the array of vector registers in the array of block registers. The method further comprises loading the results in the array of block registers into a second array of exchange registers, and loading the results from the array of block registers into memory. Each of the first and second array of exchange registers is a two-dimensional array. The method further comprises loading the results in the array of block registers into a second array of exchange registers, and loading the results in the second array of exchange registers into another array of block registers included within non-adjacent processing elements to the processing elements including the array of block registers. The method further comprises loading the results in the array of block registers into another array of block registers included within a processing element adjacent to the processing element including the array of block registers. The array of processing elements comprises a two-dimensional array. The two-dimensional array comprises a 4×4 array of processing elements. The two-dimensional array comprises a single-instruction multiple-data array. Each vector register and each block register is configured to hold 8 8-bit data elements as a two-dimensional 2×4 block of pixels or 4 16-bit data elements as a one-dimensional vector. Each processing element further comprises a plurality of scalar registers such that processing the data blocks includes processing data blocks loaded from the array of block registers and data loaded from the array of scalar registers. The local controller utilizes the accumulated results to make control decisions related to video processing.

In yet another aspect, a programmable array of processing elements processes video, each processing element including local registers to store video data blocks received from a main memory, to process the received video data blocks, and to store results of processing the video data blocks. The programmable arrays of processing elements is coupled to a local controller to provide instructions and parameters related to data transfer and processing of the video data blocks received from the main memory. The local controller provides control commands to each processing element, performing control and processing operations on data stored within the local controller, and transfers data between the local controller and other registers within one video module. The array of processing elements comprises a two-dimensional array. The two-dimensional array comprises a 4×4 array of processing elements. The two-dimensional array comprises a single-instruction multiple-data array. Each processing element includes a plurality of vector registers and a plurality of block registers. Each vector register and each block register is configured to hold 8 8-bit data elements as a two-dimensional 2×4 block of pixels or 4 16-bit data elements as a one-dimensional vector. Each processing element further comprises a plurality of scalar registers. Each processing element includes a local accumulation register. Each processing element further comprises a plurality of control registers including a PE mask register, a condition register, a block base register, and a vector base register.

### BRIEF DESCRIPTION OF THE DRAWINGS

FIG. 1 illustrates a video platform architecture including multiple video modules.

FIG. 2 illustrates a block diagram of a video module illustrated in FIG. 1.

FIG. 3 illustrates a block diagram of a processing element illustrated in FIG. 2.

FIG. 4 illustrates a block diagram of the block load/store unit illustrated in FIG. 2.

FIG. 5 illustrates a block diagram of the global accumulation unit illustrated in FIG. 2.

FIG. 6 illustrates an exemplary data flow during the motion estimation step of video encoding algorithms through the video platform architecture illustrated in FIG. 1.

### DETAILED DESCRIPTION OF THE PREFERRED EMBODIMENT

A video platform architecture for video processing includes complex video compression/decompression algorithms in a computer with a two-dimensional Single-Instruction Multiple-Data (SIMD) array architecture. The video platform architecture includes one or more video processing modules, on-chip shared memory, and a general-purpose RISC central processing unit CPU used as a system controller. Each video processing module, or video module, includes a rectangular array of processing elements (PEs), a block load/store unit, and a global-accumulation unit.

Video to be processed is configured into blocks of data. A plurality of registers are provided in the processing elements and the block load/store unit to support two-dimensional processing of the data blocks. Types of registers used include block registers, vector registers, scalar registers, and exchange registers. Each of these registers is designed to hold a short ordered one- or two-dimensional set of video data (data blocks). These registers are arranged in a hierarchical configuration along the data flow path between the on-chip memory and processing units within the PE array.

Each vector or block register is capable of holding a small I×J (e.g., 2×4 8-bit or 1×4 16-bit) data block. In a first embodiment, each PE includes 16 vector registers, 16 block registers, and 4 scalar data registers, and the block load/store unit includes 2 exchange registers. Each of the 2 exchange registers includes M banks and is capable of holding M*I×N*J 2D data blocks, where M is the number of columns of the PE array, and N is some positive integer value. In the first embodiment of the video platform architecture, I=1 or 2 (depending on the data type), J=4, M=4, and N=8, where M is chosen to match the number of columns in the PE array. Thus, the maximum size of two-dimensional data blocks that each of the 2 four-bank exchange registers are configured to hold is either 8×32 bytes (pixels) or 4×32 16-bit half words.

Means are provided to implement a data flow path via distinct transfer and data alignment steps. One such step includes transferring data between the on-chip memory and the two-dimensional exchange registers in the block load/store unit when performing one- and two-dimensional block load/store instructions. In the first embodiment, the on-chip memory holds the video data arranged sequentially in either a row- or column-major manner. Other steps include moving data between the exchange registers in the block load/store unit and the block registers within the PE array, moving data between the block registers and the vector registers within PEs of the PE array, processing data blocks in each PE using data either from a pair of any of the PE's vector and scalar registers or from the PE's local accumulator as input operands to functional units within the PE, the results are placed into one of any of the PE's vector and scalar registers or the local accumulator, moving data between any of the block registers of adjacent PEs within the PE array, and moving data from any of the block registers to one of the exchange registers (XR1), while simultaneously performing a specified horizontal shift (data alignment) of their elements and further loading the aligned data blocks into any of the block registers of non-adjacent PEs or storing them in memory.

Arranging the registers in a hierarchical configuration allows data alignment, transform, and processing operations to be performed on one- and two-dimensional data in registers rather than on-chip memory, as is done in many conventional image/video processing techniques. Performing such operations using registers instead of on-chip memory provides significant performance benefits.

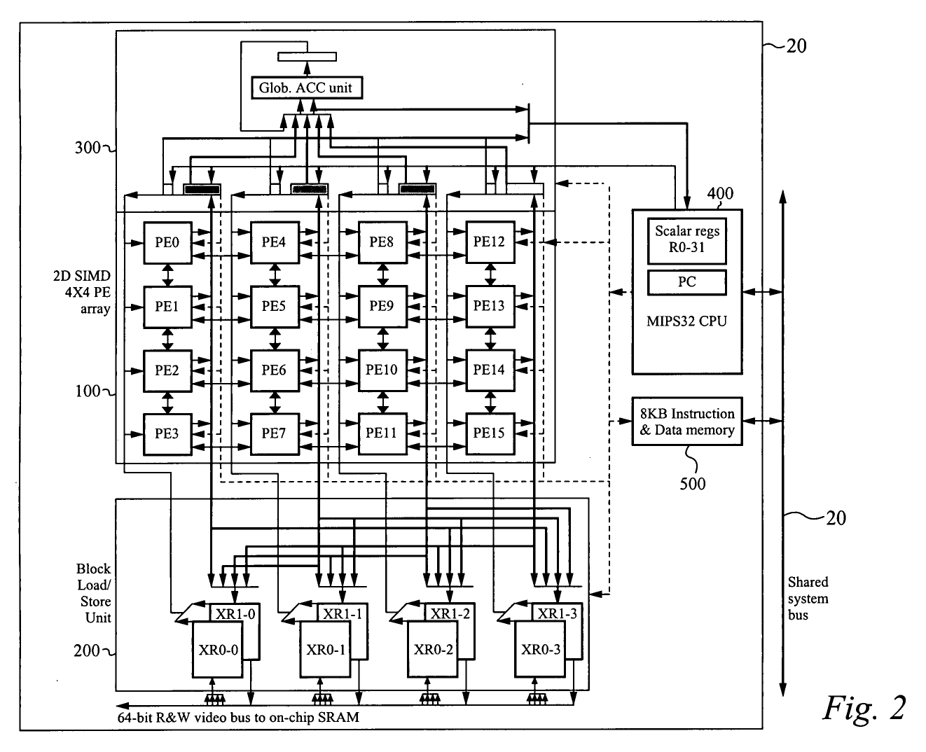

The distributed organization of block and vector registers across a rectangular PE array provides a good match for the data organization in video applications where processing is done on rectangular data blocks of a relatively small size, from 2×2 to 16×16 bytes. Such a distributed organization provides programmable register storage with high-speed and high-bandwidth access to video data loaded into the registers. Also, high-bandwidth register transfer between block registers of neighboring PEs enables high communication efficiency via transfer of the data once loaded/calculated in one PE to another PE without the necessity of loading the data from memory. Non-local data transfer between block registers of non-adjacent PEs in the PE-array is performed using two steps. During the first step, data from any of the block register(s) selected as a source are loaded into the XR1 exchange register (FIG. 2). The 4 register banks available in the XR1 exchange register are connected to the 4 columns of the PE array through a 4×4 crossbar data switch allowing data from any column to be loaded into any bank of the exchange register XR1. Such configuration of the exchange registers gives two opportunities for fast and flexible data transfer, namely parallel data transfer data from all 4 “source” PEs belonging to one selected row of the PE array, and data alignment performed during the transfer when the destination register bank for a data block from each of the source PEs is calculated by the modulo 4 addition of the source PE column and the horizontal (bank) offset specified in the instruction moving data from a selected block register in the source PEs to the XR1 exchange register. Similar data alignment can be performed when loading data blocks from memory into the XR0 exchange register (FIG. 2). During the second step, the aligned data from the XR1 exchange register are loaded into the specified destination block register of the target PEs belonging to one selected row of the PE array.

Processing operations in each PE are performed on data in vector and scalar registers. In conventional vector processing architectures, the elements of one or more vector registers are successively transmitted to the input of a functional unit, and the results from the output of the functional unit are successively written as the elements of one of the vector registers. In these architectures, the length of vectors to be processed is determined by the value in a vector length register.

Compared to such conventional vector architectures, the video platform architecture provides parallel vector processing in each PE. Specifically, means are provided to read all elements of one or two source vector registers in each PE simultaneously, process the read elements by a set of identical arithmetic-logical units (ALUs), and write back all results to one of the vector registers, all of which occurs in one PE cycle. No vector length register is involved. When necessary, the value of a condition mask register is calculated as a result, and later used in conditional merge operations to specify which elements of the destination vector register are to be changed as a result of such conditional operations. In the first embodiment, the condition mask register is a bit vector with one bit per each data element in a vector register.

To provide such parallel vector processing capabilities, the datapath of each PE is built as a set of identical PE processing slices, each of which includes an integer arithmetic-logical unit (ALU), a vector register bank, and a block register bank. The number of processing slices corresponds to the vertical size (length) of block and vector registers, or in other words, the maximum number of rows (J) of I×J data blocks that are capable of being held in these registers. Each block or vector register bank J holds I elements of row J of all block or vector registers available in a processing element. In the first embodiment of the architecture, each block and vector register holds 4 rows of data elements (e.g., J=4), with either 2 8-bit data elements (pixels) or 1 16-bit half word element per row.

In the first embodiment, each block register bank has one read port compared to two read ports in each vector register bank. Each of the PE processing slices within a given PE share a local accumulation unit, four scalar registers each capable of holding I row elements, a status and control register, and vector and block base registers. The vector and block base registers provide a relative register addressing mode in addition to a traditional absolute register addressing mode for vector and block base registers supported by the architecture. In a relative addressing mode, the physical block/vector register number is calculated by a modulo N addition of the register offset value from an instruction and the current value of the block/vector base register, where N is the number of block/vector registers available in a processing element. In a traditional absolute register addressing mode, a physical register number is specified directly by the value of the corresponding instruction field. Such segmentation of each PE's datapath into identical slices provides the scalable PE design that can be tuned for applications with different performance and power requirements.

As discussed above, the first embodiment of the processing element has 16 vector registers and 16 block registers, each capable of holding 2×4 8-bit, e.g., I=2 and J=4, or 1×4 16-bit data blocks, e.g., I=1 and J=4. Thus, each PE in the first embodiment has four processing slices, while each vector and block register bank J holds two 8-bit elements or one 16-bit element belonging to row J of I×J data blocks in each of the 16 vector and block registers.

Each vector register bank has two read and one write ports, each of width I. The instruction set of processing elements allows PE operations to specify any of the vector register as one/two data sources and any of the vector registers as a destination for the operations. When performing operations on vector registers, two input data values of width I are read from each vector register bank and one result of width I is written into each vector register bank in each of the J processing slices within each PE. The ALU available in each processing slice processes all I elements of two sources, and then writes back I results to its vector register bank simultaneously. One of the input values of width I can be read from a scalar register selected from any of PE's scalar registers and then broadcasted to all processing slices as input. A result of an ALU operation can be written into one of any of PE's scalar registers, and some operations write their results into the condition register or the local accumulator.

In the first embodiment of the architecture, each ALU within each processing slice calculates and writes back either two 8-bit results (I=2) or one 16-bit result (I=1) each cycle. Thus, in each PE cycle, all data elements of two input 2×4 or 1×4 blocks are processed using the 4 PE processing slices. Some operations, e.g., multiply and accumulate, take more than one cycle.

Each block register bank in each of the J processing slices available in each PE has one read and one write port of width I, so one value of width I is read and one value of width I is written each cycle. When moving data between vector and block registers, all data elements of a I×J data block that is held in any of vector/block registers are transferred in one cycle. In the first embodiment the value of I is either 2 (for 8-bit data types (used typically for 8-bit pixels) or 1 (for 16-bit half word values), and J=4, one dimensional I×J data block has 8 elements. Thus, either eight 8-bit pixels or four 16-bit half word values can be transferred between any vector and any block register in each PE each cycle.

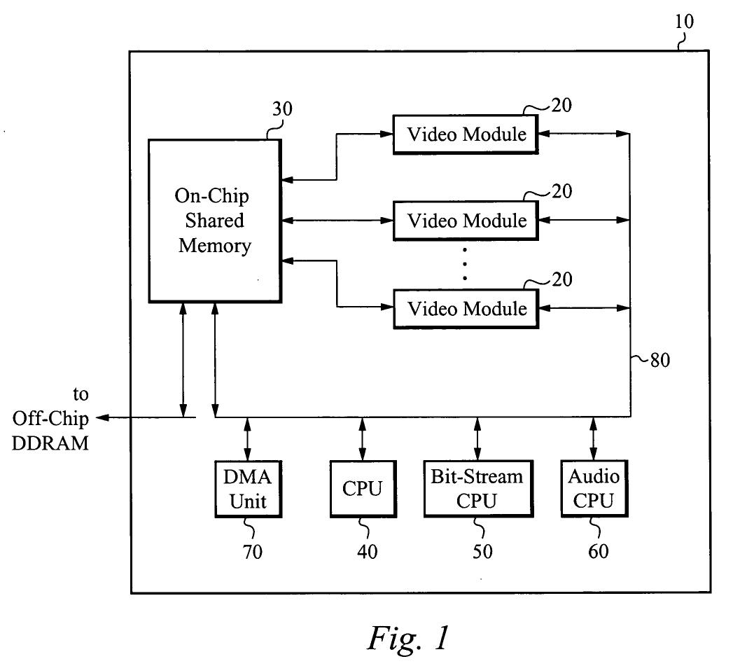

FIG. 1 illustrates a first embodiment of a video platform architecture 10 including multiple video modules 20. The video platform architecture 10 also includes an on-chip shared memory 30, a system central processing unit (CPU) 40, a bit stream CPU 50, an audio CPU 60, and a direct memory access (DMA) unit 70, all coupled together by a system bus 80. In the first embodiment, the CPU 40 is a 32 bit RISC CPU and the audio CPU 60 is a 32-bit audio CPU preferably extended with floating-point processing capabilities. Alternatively, the audio CPU 60 is a 32-bit audio CPU not extended with floating point processing capabilities. In the first embodiment, the on-chip shared memory 30 includes a 128 KB SRAM and a plurality of read/write buffers. Also in the first embodiment, the video platform architecture 10 is coupled to an off-chip DDRAM (not shown). In an alternative embodiment, the video platform architecture includes a single video module 20. In this alternative embodiment, the use of a dedicated audio CPU, such as the audio CPU 60, is avoided by implementing audio processing in a local CPU included within the single video module 20, where the local CPU is extended with floating-point capabilities, if necessary.

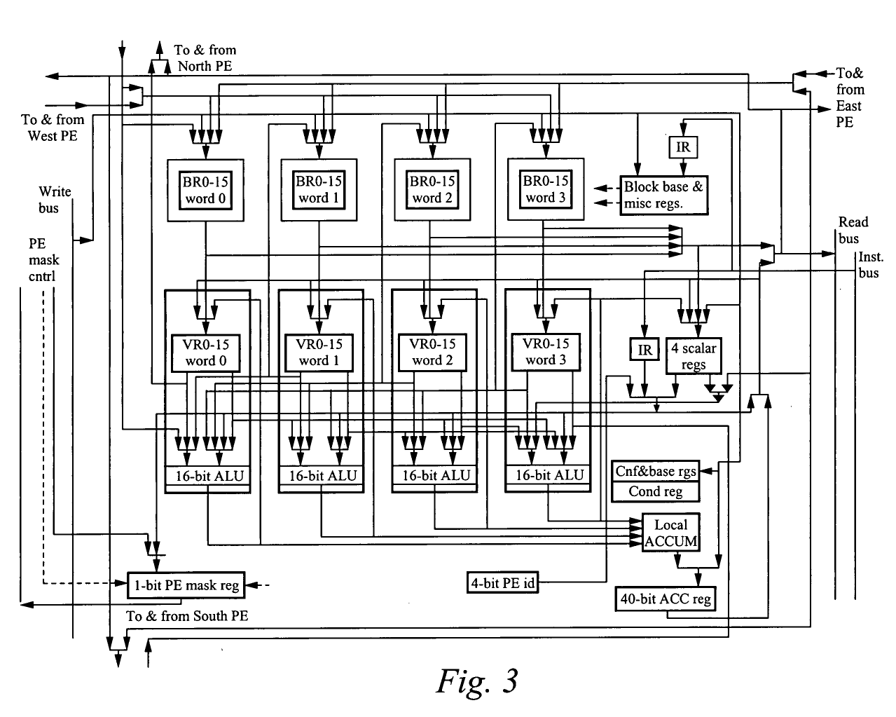

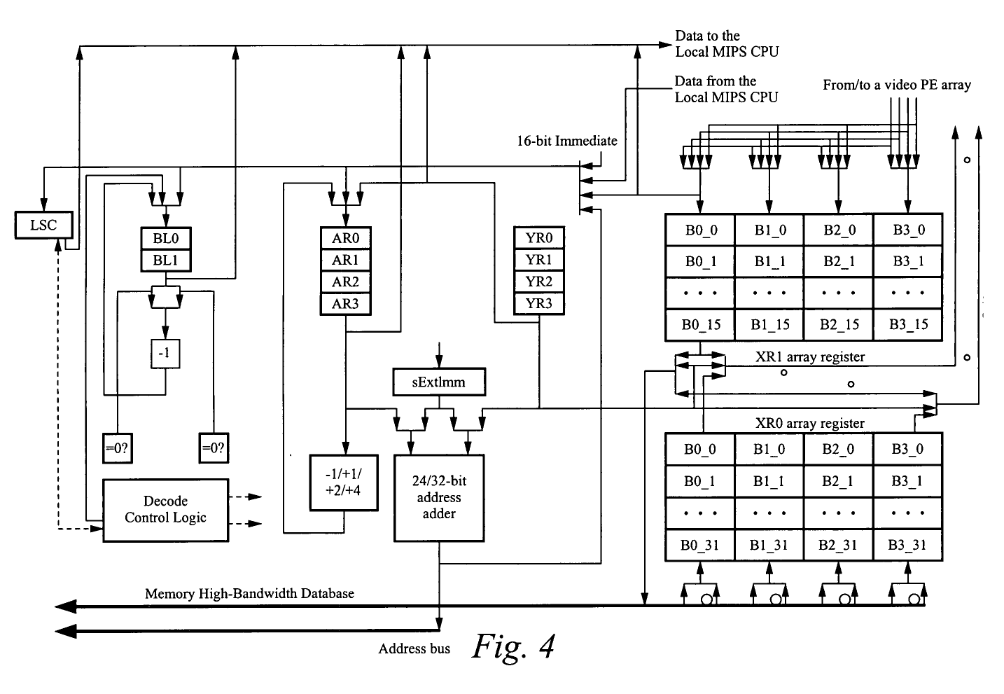

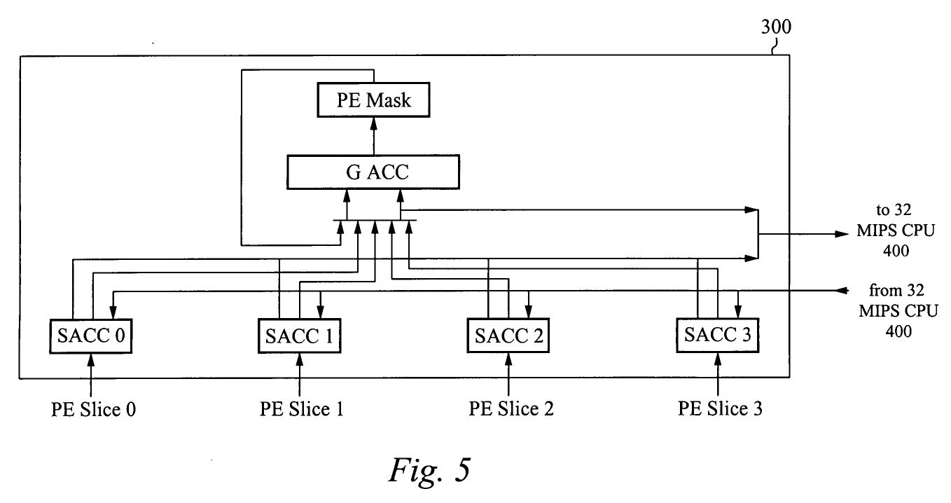

FIG. 2 illustrates a block diagram of the video module 20 illustrated in FIG. 1. The video module 20 includes a processing element (PE) array 100, a block load/store unit 200, a global accumulation unit 300, a local CPU 400 and an instruction and data memory 500. In the first embodiment the local general-purpose CPU 400 is a 32-bit MIPS CPU and includes 32 scalar registers, and the instruction and data memory 500 is an 8 KB memory. All other units of the video module 20, such as the PE array 400, the block load/store unit 200, and the global accumulation unit 300, are implemented as a video co-processor to the local 32-bit MIPS CPU and connected to the latter through the standard MIPS co-processor interface. The block load/store unit 200 of each video module 20 is connected to the on-chip shared memory 30 (FIG. 1) via a direct high-bandwidth data path. Alternatively, one high-bandwidth bus is shared by all video modules 20. In the first embodiment, the PE array 100 is a two-dimensional SIMD (single-instruction multiple-data) 4×4 PE array, including 16 video processing elements (PEs). Each processing element within the PE array 100 is described in detail below in reference to FIG. 3. The block store/load unit 200 is described in detail below in reference to FIG. 4. The global accumulation unit 300 is described in detail below in reference to FIG. 5. Each video module 20 has a parallel heterogenous architecture extending a conventional RISC (reduced instruction set computer) architecture with support for video processing in the form of the two-dimensional SIMD 4×4 PE array 100, the block load/store unit 200, and the global accumulation unit 300. The 4×4 PE array 100 is configured according to 4 vertical slices, each vertical slice including 4 processing elements. As shown in FIG. 2, a first vertical slice includes PEs 0-3, a second vertical slice includes PEs 4-7, a third vertical slice includes PEs 8-11, and a fourth vertical slice includes PEs 12-15. All PEs in each slice share their own set of buses, such as a 32-bit instruction bus, a 16-bit data read bus, a 16-bit data write bus, a 1-bit PE mask read bus, and a 1-bit PE mask write bus, with each of the buses having its own set of control signals.

FIG. 3 illustrates a block diagram of a first embodiment of a video processing element (PE) included within the PE array 100 illustrated in FIG. 2. In the first embodiment, each PE includes 16 integer vector registers, 16 integer block registers, 4 scalar registers, 1 local accumulation register, 1 condition register, 1 PE mask register, 1 block base register, 1 vector base register, 1 PE status/control register, and a partitioned integer ALU (arithmetic logic unit). In the first embodiment, the partitioned integer ALU executes 8 8-bit or 4 16-bit operations per cycle, which results in 128 8-bit operations per cycle per video module.

ALU data processing operations are performed on vector registers and scalar registers only. Each vector register includes 4 16-bit half words. Each 16-bit value of each half word is considered either as 2 packed 8-bit values called bytes or one 16-bit value called a half word. Each 16-bit value is either signed or unsigned. Access to vector registers is done either in absolute or relative register modes. For the relative register mode, the PE's vector base register is used. In order for values in a vector register to be moved from the PE to the block load/store unit, the value in the vector register is moved to one of the PE's block registers. In the first embodiment, there are 16 vector registers per PE, 4 16-bit half words per vector register, and 2 pixels per half word.

Block registers serve as an intermediate register level allowing the exchange of data between the PE and the block load/store unit, or between two PEs, to proceed in parallel with operations on vector registers inside PEs. In the first embodiment, there are 16 block registers (BRs) per PE, each block register holding 4 16-bit data half words. The block registers are used for exchanging data between the PE and a neighboring PE, and between the PE and the block load/store unit. In order to be processed by ALUs, data in the PE's block register is moved to one of the PE's vector registers. All data exchange operations on block registers expect 16-bit operands in each half word of the data block. The number of half words to be moved is either implicitly known to be the full length of a block register, e.g. 4, or specified in block move instructions. In the first embodiment, there are 16 block registers per PE, 4 16-bit half words per block register, and 2 pixels per half word. In the absolute register addressing mode, only the first 4 of the 16 vector or 16 block registers in each PE are accessible by vector/block instructions. In the relative register addressing mode, any of the 16 vector or 16 block registers in each PE are accessible by vector/block instructions.

The block base register and the vector base register provide the capability of addressing block and vector registers indirectly using a base addressing mode. In the first embodiment, the block base register is a 4-bit register, and the vector base register is a 4-bit register. The physical vector/block register number of source/destination vector/block register is calculated as follows. For each of the vector/block register operands, an instruction provides a 5-bit register ID field, consisting of a one-bit mode field, and a 4-bit register offset field. The mode bit specifies which mode, absolute (when the value of the bit is 0) or relative (when the value of bit is 1), is to be used to calculate the physical register number of this operand. In the relative addressing mode, the physical block/vector register number is calculated by the modulo 16 addition of the value of a 4-bit register offset field and the current value of the 4-bit block/vector base register. When the mode bit indicates the absolute addressing mode, the physical register number is specified directly by the value of the 4-bit register offset field.

Scalar registers are used as the second source or destination register in ALU operations. When a scalar register is specified as the destination register for an ALU operation, the value written into this scalar register is the value otherwise written into the last half word of a vector register, if the latter was the destination for the result. When a scalar register is specified as a source register, its value is broadcast to all ALUs within the PE as an input vector, where the input vector value is the value from the scalar register. In the first embodiment, each PE includes 4 16-bit scalar registers and 4 16-bit ALUs.

The local accumulation register (LACC) is either one 40-bit field or 2 20-bit fields. The values of these fields is set as a result of multiply, add, subtract, and accumulate operations, and the operation of calculating the sum of absolute differences (SAD) of 8 pixels (bytes) in two source vector registers. Each PE's 40-bit LACC is read in steps, specifying which part of the LACC, low 16 bits, middle 16 bits, or high 8 bits, are to be placed on the 16-bit bus connecting each PE slice to the global accumulation unit and the block load/store unit.

The condition register, also referred to as the condition mask register, acts as an implicit source in conditional move operations on vector registers. In the first embodiment, the condition mask register has 8 bits. All bits are set as a result of byte compare operations on 8 bytes in vector source register(s). Only 4 (even) bits are set when compare instructions operate on 4 16-bit half words, and the remainder of the bits are set to zero.

The PE mask register is written either from outside the PE by the control MIPS CPU 400 (FIG. 2) via a global PE mask register, which is described in greater detail below, or by the PE itself as a result of internal move operations which sets the PE mask register. During computation, when necessary, the local CPU 400 (FIG. 2) excludes some PEs from processing by setting their masks to zero. Later, each of the “active” PEs, that is those PEs not excluded by the local CPU 400, is capable of excluding itself from the computation by calculating a required condition and loading it into its own PE mask register. When necessary, the local CPU 400 reactivates such “sleeping” PEs by loading their PE mask registers with non-zero values. With the condition mask register and the PE mask register, the video platform architecture is able to support parallel conditional operations within the two-dimensional PE array. The ability of each PE to exclude itself from computations within the two-dimensional PE array based on conditions calculated by ALUs inside the PE and written into PE masks, avoids the necessity of performing all control decisions for each individual PE by the video module's local CPU 400. The local CPU 400 typically performs global control decisions. As for local conditions dependent on data within block and vector registers, all PEs are capable of calculating these conditions in parallel. The calculated conditions are then used to either mask the PE in or out of computation by loading these conditions into the PE mask register, or used in conditional data move/merge operations controlled by contents of the condition masks to replace conditional branches.

A PE ID register is a read-only register that specifies the physical ID of the PE within the PE array. The PE ID register is used in shift operations to select bits related to each PE, when input half words are compressed bit vectors including information about all PEs in the PE array. In the first embodiment, the PE ID register is 4-bits.

When moving data between the block load/store unit (e.g., to/from exchange registers) and PEs in the PE array in parallel with current processing in the PE array, it is necessary to select which of the PE are to participate in such data move operations within a video module. Logically, instructions moving data blocks between exchange and block registers specify either a whole PE array or only PE(s) in one row of the PE array involved in the operations. Since the number of half words that are read from exchange register cannot exceed the number of columns of the PE array, the hardware in the block load/store unit implements the data move operation on a whole PE array with 4 data move operations, one per each row of the PE array. The selection of the source/destination PE row is done using a relative addressing mode with the PE row base register. The physical PE row address is calculated by unsigned modulo 4 addition of the contents of the PE row base register and PE row offset value from the corresponding data move instructions. In the first embodiment, the PE row register is 2-bits and the PE row offset value is 2-bits.

FIG. 4 illustrates a block diagram of a first embodiment of the block load/store unit 200 illustrated in FIG. 2. In the first embodiment, the block load/store unit 200 includes 2 data exchange block buffers (XR0 and XR1 array registers), 4 address registers (AR0-AR3), 4 index registers (YR0-YR3), 2 block length registers (BL0 and BL1), and a block load/store status/control register (LSC). The block load/store unit 200 also includes an address adder and other adders used to calculate memory address and post-increment/decrement address and block length registers during block transfer operations.

The XR0 and XR1 array registers are global exchange array registers. In the first embodiment, both the XR0 and XR1 array registers are two-dimensional memory arrays including 4 columns, also referred to as banks, each one half-word wide and 32 half-words deep. Output of each bank is connected to the corresponding PE slice's write data bus. The high-bandwidth memory bus is connected to an input port of each bank of the XR0 array register via a 4-to-1 multiplexor, which allows data from on-chip memory 30 (FIG. 1) to be aligned before loading them into the XR0 array register. During operation, all banks of each XR0 and XR1 array register are capable of reading or writing data. Read/write operations on the XR0 and XR1 array registers use 4-bit vectors as masks specifying which of the banks participate in the operations. The XR0 array register is used as the implicit destination register when loading input data blocks from on-chip memory 30 (FIG. 1) into the block load/store unit 200 (FIG. 2). Then, these data are moved to selected block registers of PEs in the PE array 100 (FIG. 2). Before processing these data, each PE moves the data from the block register to any of the vector registers. In order to store PE results in memory, the results from the PE's vector register are first moved to any of the PE's block registers, then to the XR1 array register, from which they can be stored in memory by block store instructions. The XR1 array register is also used as an intermediate data aligning buffer in global data exchange operations between non-adjacent PEs in the PE array 100 (FIG. 2). In these operations, data from a block register of a selected set of PEs belonging to one row of the PE array 100 are moved into the XR1 array register by one data move instruction, if necessary being aligned before written into the XR1 array register's banks. Then, by executing another data move instruction, the XR1 array register data is moved into any of the block registers of any of the selected destination PEs belonging to one row of the PE array 100 (FIG. 2).

The exchange array registers, XR0 and XR1, serve as intermediate buffers in data transfer operations moving data between on-chip shared memory and block registers as well as between block registers of non-adjacent PEs. In the first embodiment, the size of each array register is 4×32 16-bit half words, the size allowing each array register to hold one full 16×16 byte block, e.g., a full 16×16 macroblock of pixels.

One- and two-dimensional half word/word blocks are loaded from on-chip shared memory into the array register XR0 and moved from the array register XR1 to on-chip shared memory. Because an identification of the array registers during load/store operations are always known, these identifications need not be specified in the corresponding load and store instructions operating with these array registers. Rather than specifying an identification specific to an array register, the load/store instructions specify the layout of data, e.g, how words/half-words are to be loaded into or fetched from four banks available in each of the two array registers XR0 and XR1. Each of these four banks represents one column of an exchange array register.

During load/store of a half word block or the global data exchange operations, four half words, each from a different bank, are written or read to/from an exchange array register simultaneously during one video module cycle. During the load/store word block operations, two half words are written or read to/from each exchange array register bank sequentially during two video module cycles. The speed of a video module memory bus is expected to be half of the video platform video module clock speed. The banks involved in these block transfer operations are specified by a 4-bit bank map field.

During data transfer, the bank from which the first word/half word is read from or written to is specified by the leading non-zero bit of the bank map field. Other non-zero bits, if any, show the banks from which other words/half words are to be read or written to, all with the same row address as the row address used for the first half word. After all words/half words specified by nonzero bits of the bank map field are read/written, the row address for the array register involved in the data transfer is incremented by the vertical (half word) stride before the next group of half words is read/written from/to the array register.

The vertical stride is either one, as in a load/store instruction, or is specified by the corresponding field in the block transfer instructions moving data between the array register XR1 and the PEs' block registers. The initial row address is specified by a vertical half word offset field in the block transfer instructions.

Address registers are used in all load/store instructions within the block load/store unit 200. When involved in one and two dimensional data transfer between on-chip shared memory 30 (FIG. 1) and a video processor module 20 (FIG. 1), the corresponding address registers are post-updated by a corresponding stride value (+1/−1) after initiating each load/store word/half-word operation. In the first embodiment, there are 4 24/32-bit address registers (AR0-AR3) in the block load/store unit 200.

Index registers and block length registers are involved in two-dimensional block transfer operations. In the first embodiment, the block load/store unit 200 includes 4 16-bit index registers (YR0-YR3) and 2 16-bit block length registers (BL0-BL1).

The structure of the block load/store status/control (LSC) register is established based on the communication protocol between the local 32-bit MIPS CPU 400 (FIG. 2) and the block load/store unit 200. A condition control field within the LSC register includes 8 condition bits that are checked by the 32-bit MIPS CPU 400. In the first embodiment, there is one LSC register in the block load/store unit 200.

FIG. 5 illustrates a block diagram of a first embodiment of the global accumulation unit 300 illustrated in FIG. 2. In the first embodiment, the global accumulation unit 300 includes 4 slice accumulation (SACC) registers, 1 global PE mask control register, and 1 global accumulation (GACC) register.

There is one SACC register for each vertical PE slice of the PE array 100 (FIG. 2). The SACC registers are the intermediate registers in the operations moving data from the LACC register of each PE to the GACC register. In the first embodiment, there are 4 40-bit SACC registers in the global accumulation unit 300. Each of the SACC registers includes three individually written sections, namely low 16-bits, middle 16-bits, and high 8-bits. Each PE's 40-bit LACC is read in steps, specifying which part of the LACC, low 16-bits, middle 16-bits, or high 8-bits, is to be placed on the 16-bit bus to the global accumulation unit 300, and finally into corresponding section of the appropriate SACC register. During operation of the global accumulation unit 300, either the full 40-bit values or packed 20-bit values of the SACC register involved in the accumulation operations are added together by a global add instruction and a global add and accumulate instruction.

The GACC register is used to perform global accumulation of LACC values from multiple PEs loaded into the corresponding SACC registers. In the first embodiment, there is one 48-bit GACC register in the global accumulation unit 300.

The contents of the global PE mask control register represents the compressed vector of the local PE mask registers. In the first embodiment, there is one 16-bit global PE mask control register. When loading data into the global PE mask control register, all 16 local PE mask registers are set by the values of their representative bits in the global PE mask control register. When moving data from the local PE mask registers in the PE array 100 to the block load/store unit 200, all 16 1-bit values from the local PE mask registers are packed as 1 16-bit vector which is loaded into the global PE mask control register.

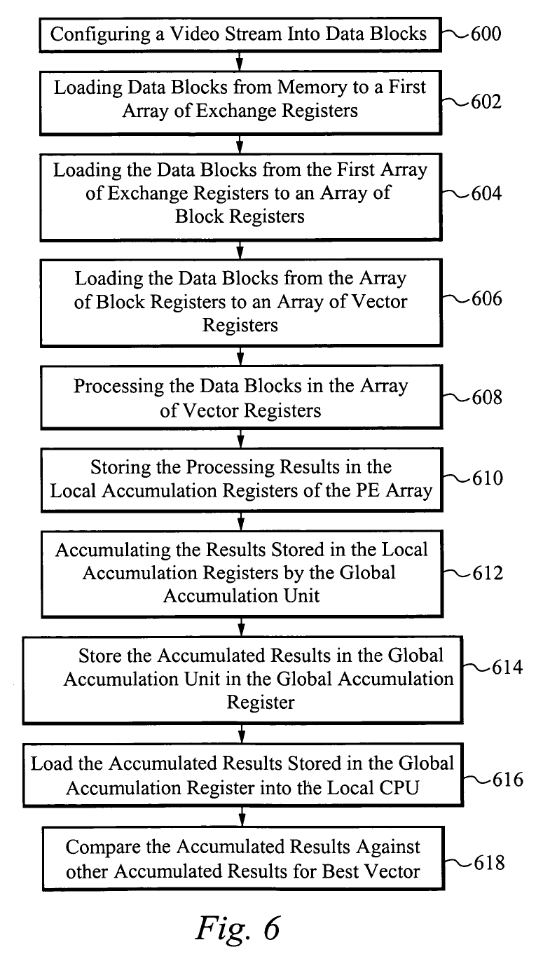

FIG. 6 illustrates an exemplary data flow during the motion estimation step of video encoding algorithms through the video platform architecture illustrated in FIG. 1. At the step 600, a video stream is configured into data blocks. At the step 602, data blocks are loaded from memory to a first register in an array of two-dimensional exchange registers. At the step 604, data blocks are loaded from the first register in the array of two-dimensional exchange registers to a programmable array of processing elements. Each processing element within the array of processing elements includes an array of block registers and an array of vector registers. The data blocks are loaded from the first register in the array of two-dimensional exchange registers to the array of block registers. At the step 606, the data blocks are loaded from the array of block registers to the array of vector registers. At the step 608, the data blocks loaded in the array of vector registers are processed, e.g., the sum of absolute differences (SAD) between the 16×16 pixel macroblock loaded into the array of vector registers at the step 606 and the reference 16×16 pixel macroblock of the current video frame loaded into the array of vector registers earlier is calculated. At the step 610, the results of the step 608 are stored in the local accumulation registers of the PE array, with one local accumulation register per each processing element. At the step 612, the results stored in the local accumulation registers of the PE array (in the current embodiment each corresponding to the SAD of 4×4 pixels sub-blocks) are accumulated by the global accumulation unit. At the sep 614, the global accumulation result is stored in the global accumulation register. At the step 616, the global accumulation result stored in the global accumulation register is loaded into one of the general-purpose registers of the local CPU 400 (FIG. 2). At the step 618, the global accumulation result is compared by the local CPU 400 against other accumulation results for this macroblock of the current video frame, and depending on the results of this comparison the search of the best motion vector for this macroblock of the current video frame will be either stopped or continued.

In operation, a video stream is received by a video platform architecture including an on-chip shared memory, a system controller, and one or more video processing modules. The on-chip memory holds the received video stream as a sequence of data blocks, which are then sent to the video processing modules. Each video processing module includes a local controller, a block load/store unit, a programmable single-instruction multiple-data processing element array, and a global accumulation unit. Data blocks are received from the on-chip shared memory by the block load/store unit. The block load/store unit includes one or more exchange array registers. A first exchange array register receives the data blocks from the on-chip memory. The processing element array is a two-dimensional array of processing elements. Each processing element includes vector registers, block registers, scalar registers, arithmetic logic units (ALUs), and a local accumulation register (LACC). The number of columns in each exchange array register is equal to the number of columns in the processing element array. Data blocks loaded into the first exchange array register are loaded into the block registers of corresponding processing elements. To process data blocks, data must be loaded into the vector registers. Therefore, when processing is required, the data blocks are loaded from the block registers to the vector registers within a given processing element.

Processing of the data blocks in the vector registers is then performed in each or some PEs, the results of which are written back into any of the vector registers and the scalar registers, or into PEs' local accumulation registers. The latter register is used in accumulation-type operations (e.g., during motion estimation as shown in FIG. 6 or when performing matrix multiply operations with multiply-add-and-accumulate operations). Some video processing steps, e.g., motion estimation, require the local accumulation result stored in LACC of individual PEs in the PE array to be further accumulated over some sub-set or all PEs in the PE array. In this case, the results of each or some sub-set of LACCs in the processing element array are sent to the global accumulation unit, where global accumulation of these LACC values from the selected processing elements is performed. The global accumulation result is then read by the local CPU into one of its general-purpose registers to be analyzed, and the control decision is made based on the result of this analysis. In some cases (e.g., during motion estimation or interpolation), in order to calculate the result, a processing element requires additional data stored in neighboring PEs' block registers. Such data are sent and received by PE's block registers through local PE-to-PE data links connecting each PE (except those at the boundaries of the PE array) to its neighbors. When the non-local data required for processing are located in non-adjacent PEs, these data are sent to the XR1 array register first and then from the XR1 array register to the PEs that need them. The availability of multiple block and vector registers within each PE and multiple links connecting PEs in the PE array provide a video module with register storage and data bandwidth large enough to keep, reuse, and transfer multiple video data blocks within the PE array, thus significantly decreasing the memory traffic between the video module and the on-chip memory.

When necessary, the processed data blocks written back to the vector registers are then loaded into the block registers, where they are sent to a second exchange array register within the block load/store unit. From the second exchange array register, the data blocks are sent to the on-chip memory. The system CPU 40 loads a set of parameters to the DMA unit 70, and the latter transfers the data from the on-chip memory 30 to the off-chip DDRAM/SDRAM. When necessary, the reconstructed video data stored in the off-chip DDRAM are sent to a display.

The present invention has been described in terms of specific embodiments incorporating details to facilitate the understanding of principles of construction and operation of the invention. Such reference herein to specific embodiments and details thereof is not intended to limit the scope of the claims appended hereto. It will be apparent to those skilled in the art that modifications may be made in the embodiment chosen for illustration without departing from the spirit and scope of the invention.

1. A video processing apparatus comprising:
a. a memory; and
b. one or more video processing modules, each video processing module coupled to the memory and comprising:
i. a programmable array of processing elements, each processing element including local registers to provide data used in processing operations and to store results of the processing operations;
ii. a block load and store unit coupled to the programmable array of processing elements to load, store, and send data transferred back and forth between the memory and the array of processing elements;
iii. a global accumulation unit to accumulate the results of the processing operations for each processing element; and
iv. a local controller to provide instructions and parameters related to the processing operations and data transfer.

2. The apparatus of claim 1 wherein the array of processing elements comprises a two-dimensional array.

3. The apparatus of claim 2 wherein the two-dimensional array comprises a 4×4 array of processing elements.

4. The apparatus of claim 2 wherein the two-dimensional array comprises a single-instruction multiple-data array.

5. The apparatus of claim 1 wherein each processing element includes a plurality of vector registers and a plurality of block registers.

6. The apparatus of claim 5 wherein each vector register and each block register is configured to hold 8 8-bit data elements as a two-dimensional 2×4 block of pixels or 4 16-bit data elements as a one-dimensional vector.

7. The apparatus of claim 1 wherein the block load and store unit comprises one or more arrays of exchange registers.

8. The apparatus of claim 7 wherein each array of exchange registers is a two-dimensional array.

9. The apparatus of claim 1 wherein the local controller provides control commands to each processing element, performing control and processing operations on data stored within the local controller, and transfers data between the local controller and other registers within one video module.

10. The apparatus of claim 1 further comprising a system controller coupled to the memory and to the one or more video processing modules.

11. The apparatus of claim 1 further comprising a direct, high-bandwidth data path to couple each of the video processing modules to the memory.

12. The apparatus of claim 1 wherein each processing element further comprises a plurality of scalar registers.

13. The apparatus of claim 1 wherein the block load and store unit sends data transferred back and forth between non-adjacent processing elements of the array of processing elements.

14. The apparatus of claim 1 wherein each processing element includes a local accumulation register.

15. The apparatus of claim 1 wherein each processing element further comprises a plurality of control registers including a PE mask register, a condition register, a block base register, and a vector base register.

16. The apparatus of claim 1 wherein the block load and store unit sends data transferred back and forth between the local registers in the processing elements, the global accumulation unit, and the local controller.

17. A method of processing video comprising:
a. configuring a video stream into data blocks;
b. loading data blocks from memory to a first array of exchange registers;
c. loading data blocks from the first array of exchange registers to a programmable array of processing elements, wherein each processing element within the array of processing elements includes an array of block registers, an array of vector registers, and a local accumulator, the data blocks are loaded from the first array of exchange registers to the array of block registers;
d. loading the data blocks from the array of block registers to the array of vector registers;
e. processing the data blocks loaded in the array of vector registers and storing results in the corresponding local accumulator for each processing element;
f. accumulating the results stored in the local accumulators in a global accumulator, thereby forming accumulated results; and
g. moving the accumulated results into a local controller.

18. The method of claim 17 further comprising storing results from processing the data blocks in the array of vector registers, and loading the results stored in the array of vector registers in the array of block registers.

19. The method of claim 18 further comprising loading the results in the array of block registers into a second array of exchange registers, and loading the results from the array of block registers into memory.

20. The method of claim 19 wherein each of the first and second array of exchange registers is a two-dimensional array.

21. The method of claim 18 further comprising loading the results in the array of block registers into a second array of exchange registers, and loading the results in the second array of exchange registers into another array of block registers included within non-adjacent processing elements to the processing elements including the array of block registers.

22. The method of claim 18 further comprising loading the results in the array of block registers into another array of block registers included within a processing element adjacent to the processing element including the array of block registers.

23. The method of claim 17 wherein the array of processing elements comprises a two-dimensional array.

24. The method of claim 23 wherein the two-dimensional array comprises a 4×4 array of processing elements.

25. The method of claim 23 wherein the two-dimensional array comprises a single-instruction multiple-data array.

26. The method of claim 17 wherein each vector register and each block register is configured to hold 8 8-bit data elements as a two-dimensional 2×4 block of pixels or 4 16-bit data elements as a one-dimensional vector.

27. The method of claim 17 wherein each processing element further comprises a plurality of scalar registers such that processing the data blocks includes processing data blocks loaded from the array of block registers and data loaded from the array of scalar registers.

28. The method of claim 17 wherein the local controller utilizes the accumulated results to make control decisions related to video processing.

29. A video processing apparatus comprising:
a. means for configuring a video stream into data blocks;
b. means for loading data blocks from memory to a first array of exchange registers, the means for loading data blocks from memory coupled to the means for configuring;
c. means for loading data blocks from the first array of exchange registers to a programmable array of processing elements, the means for loading data blocks from the first array of exchange registers coupled to the means for loading data blocks from memory, wherein each processing element within the array of processing elements includes an array of block registers and an array of vector registers, the data blocks are loaded from the first array of exchange registers to the array of block registers;
d. means for loading the data blocks from the array of block registers to the array of vector registers, the means for loading the data blocks from the array of block registers coupled to the means for loading data blocks from the first array of exchange registers;
e. means for processing the data blocks loaded in the array of vector registers and storing results in the corresponding local accumulator for each processing element, the means for processing coupled to the means for loading the data blocks from the array of block registers;
f. means for accumulating the results stored in the local accumulators in a global accumulator, thereby forming accumulated results, the means for accumulating coupled to the means for processing; and
g. means for moving the accumulated results into a local controller, the means for moving coupled to the means for accumulating.

30. The apparatus of claim 29 further comprising means for storing results from processing the data blocks in the array of vector registers, and means for loading the results stored in the array of vector registers in the array of block registers.

31. The apparatus of claim 30 further comprising means for loading the results in the array of block registers into a second array of exchange registers, and means for loading the results from the array of block registers into memory.

32. The apparatus of claim 31 wherein each of the first and second array of exchange registers is a two-dimensional array.

33. The apparatus of claim 30 further comprising means for loading the results in the array of block registers into a second array of exchange registers, and means for loading the results in the second array of exchange registers into another array of block registers included within non-adjacent processing elements to the processing elements including the array of block registers.

34. The apparatus of claim 30 further comprising means for loading the results in the array of block registers into another array of block registers included within a processing element adjacent to the processing element including the array of block registers.

35. The apparatus of claim 29 wherein the array of processing elements comprises a two-dimensional array.

36. The apparatus of claim 35 wherein the two-dimensional array comprises a 4×4 array of processing elements.

37. The apparatus of claim 35 wherein the two-dimensional array comprises a single-instruction multiple-data array.

38. The apparatus of claim 29 wherein each vector register and each block register is configured to hold 8 8-bit data elements as a two-dimensional 2×4 block of pixels or 4 16-bit data elements as a one-dimensional vector.

39. The apparatus of claim 29 wherein each processing element further comprises a plurality of scalar registers such that processing the data blocks includes processing data blocks loaded from the array of block registers and data loaded from the array of scalar registers.

40. The apparatus of claim 29 wherein the local controller utilizes the accumulated results to make control decisions related to video processing.

41. A programmable array of processing elements to process video, each processing element including local registers to store video data blocks received from a main memory, to process the received video data blocks, and to store results of processing the video data blocks.

42. The programmable array of processing elements of claim 41 coupled to a local controller to provide instructions and parameters related to data transfer and processing of the video data blocks received from the main memory.

43. The programmable array of processing elements of claim 42 wherein the local controller provides control commands to each processing element, performing control and processing operations on data stored within the local controller, and transfers data between the local controller and other registers within one video module.

44. The programmable array of processing elements of claim 41 wherein the array of processing elements comprises a two-dimensional array.

45. The programmable array of processing elements of claim 44 wherein the two-dimensional array comprises a 4×4 array of processing elements.

46. The programmable array of processing elements of claim 44 wherein the two-dimensional array comprises a single-instruction multiple-data array.

47. The programmable array of processing elements of claim 41 wherein each processing element includes a plurality of vector registers and a plurality of block registers.

48. The programmable array of processing elements of claim 47 wherein each vector register and each block register is configured to hold 8 8-bit data elements as a two-dimensional 2×4 block of pixels or 4 16-bit data elements as a one-dimensional vector

49. The programmable array of processing elements of claim 41 wherein each processing element further comprises a plurality of scalar registers.

50. The programmable array of processing elements of claim 41 wherein each processing element includes a local accumulation register.

51. The programmable array of processing elements of claim 41 wherein each processing element further comprises a plurality of control registers including a PE mask register, a condition register, a block base register, and a vector base register.
